(19) United States
(12) Patent Application Publication
(10) Pub. No.: US 2007/0184769 A1
(43) Pub. Date: Aug. 9, 2007

(54) Biological safety cabinet

(76) Inventor: Xiang Qian Lin, Singapore (SG)

Correspondence Address: NIELDS & LEMACK, 176 EAST MAIN STREET, SUITE 7, WESTBORO, MA, 01581, US

(21) Appl. No.: 11/351,025

(22) Filed: Feb. 9, 2006

(51) Int. Cl. B08B 15/02

(52) U.S. Cl. 454/57

(57) ABSTRACT

An improved bio-safety cabinet having a microprocessor control system for the monitoring and control of the inflow, downflow and outflow of air, for creation of a performance envelope within the work chamber wherein all contaminated areas are under negative pressure or surrounded by negative pressure and the work chamber is continuously bathed in clean air, ensuring the microbiological work is protected form contamination in normal room air. Improved decontamination and other safety measures for a bio-safety cabinet are also proposed.

### FIELD OF THE INVENTION

The present invention relates to an improved Class II biological safety cabinet.

### BACKGROUND OF THE INVENTION

Biological safety cabinets (herein referred to as “biosafety cabinets”) are laboratory containment devices equipped with High Efficiency Particulate Air (HEPA) filters. These biosafety cabinets are typically used in laboratories to perform microbiological analysis and studies. The biosafety cabinets provide operator protection from exposure from microbiological infection. Most biosafety cabinets also protect the sample placed inside the cabinet from background contaminants in the laboratory room, or this is also often referred to as product protection. An example of such a Class II Type A2 biosafety cabinets had been described in U.S. Pat. No. 6,368,206 B1.

A Class II Type A2 biosafety cabinet is an enclosure with a front opening, where the operator's hands can enter the work area to perform the microbiological work. The operator is protected from microbiological agents inside the cabinet by inward-moving airflow through the front opening which is often referred to as inflow. The product/sample inside the cabinet is protected by a downward stream of clean and laminar air flow referred to as downflow. The air inside the work zone is constantly purged and replenished to prevent microbiological contaminants from “jumping” from one area to another, which is referred to as cross contamination protection. The inflow, downflow, and work zone continuous air purging inside the cabinet are driven by electric blower(s)/fan(s). Microbiological filtration inside the cabinet is performed by HEPA filters. The following is the detailed description of the biosafety cabinet.

The Class II bio-safety cabinet work zone is enclosed by side and back walls, as well as a working tray on the bottom and HEPA filter on the top. The front side has a partial/adjustable opening by a sliding sash window.

The front window opening should be set to a specified opening height when the microbiological work is performed. If the window opening is too big, the inflow velocity is too small and operator protection can be compromised. If the opening is too small, the inflow velocity is too high, so the operator's arm reach and mobility is restricted by the small opening, which can inhibit the work efficiency and safety.

When the microbiological work is not performed, the window can be moved upward for easy cleaning of the cabinet work zone or for moving large equipment into or out from the biosafety cabinet. The front opening must be completely closed when the UV lamp inside the biosafety cabinet is activated, to protect the operator from UV light exposure.

Inflow: Room air flows through the front window opening into the front grille on the work tray. Due to the cabinet design, inflow only travels as far inward as the front air grille, and does not enter the work zone to avoid product contamination.

Air return path: The inflow air stream travels through the air return path underneath the work tray and meets the downflow stream entering from the back grille. The combined stream, which is under negative pressure (lower pressure than ambient pressure), flows through the back air column, then flows around the fan housing before going into the fan inlet.

Fan/blower housing: The fan(s) inside the fan housing creates positive pressure (higher pressure relative to ambient pressure) inside the housing to push the air through the HEPA filter that would capture the microbiological contaminants. The fan housing is the most dangerous area inside the cabinet because the air inside the fan housing is contaminated and it's under positive pressure. However, the fan housing is surrounded by negative pressure created by the fan suction. Therefore, if there is some leakages through the fan housing, the contaminants will be aspirated by the negative pressure back into the fan housing and will not escape to the lab environment.

HEPA-filtered exhaust air: Approximately 35% of the air from the fan housing goes out to the room through the exhaust HEPA filter which captures the contaminant particles, thus preventing them from going out to the lab environment. Because of conservation of mass, the exhausted air is replenished by the inward moving air through the front opening (inflow), which creates the operator protection.

HEPA-filtered downflow air: The remaining 65% air from the fan housing passes through the downflow HEPA filter that creates a unidirectional (laminar) air stream that continuously “bathe” the work zone with particle-free air to provide product protection. Near the work zone surface, the downflow will split and drawn towards the front and back air grille by the negative pressure from the fan, thus continuously removing contaminants from the work zone. The downflow portion that flows towards the front air grille joins the inflow stream, creating an air barrier that prevents the contaminants inside the cabinet from escaping through the front opening and also preventing the outside contaminants from entering the cabinet work zone. Proper inflow and downflow balancing is required to ensure the dual function of this air barrier. An imbalanced cabinet can lose it's operator protection and product protection.

The HEPA filter is at least 99.99% efficient at 0.3 micron particle size, so they are deemed suitable to capture virus and bacteria that circulates inside the cabinet. A more advanced filter is called Ultra Low Penetration Air filter or commonly abbreviated as ULPA filter, which is at least 99.999% efficient at 0.12 micron particle size, thus offering a higher degree of protection than the HEPA filter.

### Problem to be Solved by the Invention

By analyzing how the biosafety cabinets operate based on the explanations above, the prior art biosafety cabinets have several drawbacks that leave room for improvement and enhancement.

### Airflow

### 1. Inflow Grille (1)—Arm Rest

The biosafety cabinets have a front airflow grille to create the front air barrier by combining inflow and downflow to create operator and product protection. Most of the prior art bio-safety cabinets have a flat inflow grill that is prone to blocking by the operator's arms, thus reducing the operator and product protection effectiveness, and in severe cases, the grille blocking may even cause a dangerous containment failure.

U.S. Pat. No. 6,368,206 B1 proposed a biosafety cabinet utilizing a radiused sash grill which can provide an ergonomic surface for operator's arm to rest on it while preventing the operator from placing objects on the grill that can block the inflow. This is coupled by a row of secondary airflow slots placed in the front of the main grill area to help maintain the inflow when the main grill is blocked by operator's arm resting on it. However, this design is not completely effective because when the operator rests his/her arms on this radiused curve, the inflow grille is already partially blocked, thus reducing the effectiveness of the containment. Therefore, a better designed inflow grille is needed to prevent even partial blocking by the operator's arms while providing an ergonomic resting place for arms.

### 2. Inflow Grille (2)—Curved Shape

In addition to possible blocking of inflow air grille by the operator's arms, it is also possible for the operator to accidentally block the inflow air grille by putting objects on it. The biosafety cabinets of the prior art have either flat inflow grilles or curved inflow grilles without an arm rest. A flat inflow grille will not prevent the user to put objects on it. Meanwhile, a curved inflow grille without an arm rest will not stop objects from falling down if the operator accidentally put objects on it. What is needed is a tray design that can prevent the user from blocking the front air grille, but will not cause such objects to fall to the floor when placed on the front grille.

### 3. Angled Filter But Straight Diffuser

Safety cabinets with sloped fronts are recommended to reduce the likelihood of the operator's view into the cabinet blocked by the reflection of the lamp placed on the laboratory's ceiling, to prevent dangerous accidents when doing risky high-precision works with a needle. A blocked view can cause self-inoculation by the needle that has killed several lab scientists if the needle is contaminated. However, a sloped window will also cause the downflow behind the window to become weak, as mentioned above. Weak downflow on this critical area can let the contaminants escape straight to the operator's breathing zone, which is very dangerous. Some safety cabinets of the prior art that have a sloped front have a sloped downflow filter or horizontally-mounted downflow filter combined with a sloped downflow diffuser. A downflow filter without a diffuser is less likely to give good downflow uniformity that can cause cross contamination. A horizontally-mounted downflow filter (without slope), combined with an angled diffuser will direct the downflow to the front but the downflow on the back will be weak and may cause cross contamination. What is needed is the downflow filter and diffuser installation that can ensure uniform downflow throughout the work area, including the front and back zone.

### Decontamination

### 1. Antimicrobial Coating

The biosafety cabinet needs to undergo formalin decontamination before the service technician can open up the contaminated area to change the HEPA filter or replace the fan. Even when performed properly, formalin decontamination can only reduce the number of hazardous microorganism inside the cabinet by a factor of 100,000 to 1,000,000, but will not achieve a complete kill of all microorganisms. In practicality, quite often only a kill factor of between 10,000 to 100,000 is achieved. A small quantity of accidental spillage can release millions of microorganisms, and over a period of years, billions or trillions of microorganisms may accumulate inside the biosafety cabinet's contaminated area. Because of the limited effectiveness of formalin decontamination, there is still a risk for the service technician to get infected when accessing the contaminated area. Therefore, it is needed to minimize the microorganisms in the contaminated area by inhibiting their growth.

### 2. Auto-Decontamination

Decontamination by formalin vapor is required to be performed before the service technician can open up the contaminated parts of the cabinet, for example when changing the HEPA/ULPA filter or changing the fan. During the formalin evaporation process, the operator needs to turn on the blower for around ½ to 1 minute when the formalin is 25%, 50%, 75%, and 100% evaporated. This is troublesome for the service technicians who need to keep track of the time to manually turn ON the cabinet's blower at the specific time. Formalin vapor is carcinogenic, and inhalation of high formalin concentration can cause coma or even death, so after sufficient contact time of at least 6 hours (although 10 hours is better), the formalin needs to be neutralized by ammonia. During formalin decontamination, the lab needs to be vacated to prevent the people from accidental exposure to formalin vapor in case there is a formalin leak through the cabinet's sealing. Because of this long contact time during which the lab must be vacated, the service technician usually starts the decontamination process at the end of the work day, around 5 pm. Considering formalin contact time of 6-10 hours, then the service technician needs to come back to the lab around 11 pm-3 am to start the ammonia vaporizer and to turn ON the cabinet blower for ½ to 1 minute when the ammonia is 25%, 50%, 75%, and 100% evaporated, which is even more troublesome. What is needed is an integrated biosafety cabinet with a formalin vaporizer that can “communicate” each other, so the cabinet blower is automatically turned ON when the formalin and ammonia has been 25%, 50%, 75%, and 100% evaporated.

### 3. UV Lamp location

A germicidal Ultra-Violet (UV) lamp is often used inside the biosafety cabinet to help kill the microorganisms inside the cabinet's work area at the end of the day, after the work inside the cabinet is done. The UV lamp is harmful for the operator or the people inside the lab who are working near the cabinet because it can cause skin cancer and eye irritation. The user should not work inside the cabinet when the UV lamp is activated and the sash window must be completely closed to prevent the UV radiation from harming the people inside the lab. The sash window is typically UV-absorbing, and it's effective to bring down the UV intensity to zero when measured just outside the glass.

The biosafety cabinets of the prior art typically have no sash window interlock system that only enables the UV lamp to be activated only when the sash window is lowered all the way down, and also automatically cuts the UV lamp then the sash window is raised, to prevent the user from accidental exposure to the harmful UV radiation.

The typical prior art biosafety cabinets have the UV lamp located on the back wall, side wall, or mounted on a removeable rack placed on the work surface. This is not a safe design because people inside the lab can still accidentally stare at the UV lamp, causing eye irritation. Even though the sash window cuts down the UV radio wave intensity to zero, the glare from staring at the UV lamp outside the sash window can be unbearable.

### Glass

### Laminated Glass—Clean from Back

The area behind the sash window must be periodically cleaned with disinfectant to prevent contaminant built-up. Due to the design, it is difficult for the user to completely clean the area behind the sash window, especially the area between the middle to the top portion of the glass. If the window is lowered, the front opening from which hands can enter the cabinet to clean the back side of the window is reduced, so hands can't reach that area. Besides, a portion of the glass usually extends above the work zone area, making it very difficult to clean that area. Therefore, a mechanism that enables the entire area behind the sash window to be cleaned is needed.

### Microprocessor

The prior art biosafety cabinets typically use only simple switches to turn on the blower and light without any airflow sensor & alarm, or a simple microprocessor system that monitors and displays the cabinet airflow and notifies the user for any unsafe condition. What is lacking is an advanced integrated microprocessor system to accurately monitor the air flow and control other crucial operating parameters of the bio-safety cabinets thus ensuring the user that the cabinet is operating within a safe limit.

### 1. Networking

Many biosafety cabinets are installed inside a biosafety level 3 containment laboratory in which the entire lab is assumed to be contaminated so the operators must wear proper protective equipment before entering the lab, and must undergo decontamination such as a chemical shower before exiting the lab. This procedure is tedious if the operator just wants to perform a simple operation on the biosafety cabinet such as turning off the auxiliary outlet. What is needed is a biosafety cabinet that is networked to the building's computer system so the cabinet can be remotely operated, such as turning ON/OFF the fan, lights, auxiliary outlet, and it's airflow status be monitored from a room outside the contaminated lab.

### 2. Multiple Downflow Sensors

A downflow sensor is installed in some biosafety cabinets to monitor the downflow velocity. The sensor only measures the air velocity at 1 point below the downflow HEPA/ULPA filter. This 1 point reading is then correlated to the average downflow reading, measured at many points, which is typically 24 points or more, and hopefully this 1 point reading can accurately represent the average reading of 24 points. The correlation becomes more inaccurate after the cabinet has been used for several years and there is an uneven particle loading on the downflow filter. It's possible that the filter area near the sensor is not seriously blocked by the dust, so the localized reading in that area is still high, although the average downflow reading is low. Therefore, multiple downflow sensors are needed.

### 3. Airflow Sensor and Filter Pressure Sensor Compensation

The operator protection by the cabinet is achieved by inflow and product protection is provided by downflow. The cabinet can provide operator and product protection when the cabinet inflow and downflow is within a specific area called the cabinet performance envelope that needs to be established by the cabinet's manufacturer. Inflow and downflow velocity of the cabinet can change in the short or long term, affecting the protection provided by the cabinet.

a. Short-term: building supply voltage variation. The supply voltage can be low during the day where all the machineries are operated, and high during the night. The speed of the motor depends on the voltage output provided by the speed controller. When the building supply voltage decreases, the voltage output from a conventional speed controller also decreases, so the cabinet inflow and downflow are reduced. What is needed is an automated speed control system that will keep the voltage supplied to the motor to be constant despite an increase and decrease in the building supply voltage.

b. Long-term: filter loading. Over a period of time, the HEPA/ULPA filter of the biosafety cabinet will gradually yield higher pressure drop due to increased filter loading by dust/particles that are captured by the filter. If the motor voltage is not increased, both inflow and downflow will decrease and will compromise the product and operator protection.

An automated speed control alone will not compensate for filter loading, and a pressure sensor system that detects changes on filter pressure drop due to filter loading will not work well for temporal/intermittent building voltage fluctuation. What is needed is an integrated compensation system that would automatically increase the motor voltage due to building supply voltage variation and filter loading.

### 4. UV Intensity Sensor

The UV lamp must be able to yield UV intensity of 40 micro Watt/cm² on the work tray to sufficiently disinfect the cabinet. Over a period of time, the UV lamp will wear out and its' intensity decreases. UV intensity measurement is not mandatory for annual certification of the biosafety cabinet. Because of cost considerations, most field certifiers do not have a UV meter to verify the UV intensity. Because prior art biosafety cabinets have no built-in UV sensor, and certifiers usually don't have UV meter, there is no way to ensure that the UV lamp intensity is still sufficient. What is needed is a biosafety cabinet that has a built-in UV lamp intensity measurement meter.

### SUMMARY OF THE INVENTION

A first object of the invention is an improved bio-safety cabinet comprising: an all metal frame defining an upper housing on top of a lower protected work chamber, said upper housing fitted with a combination of exhaust and downflow ULPA filters and a blower sealed within said upper housing to provide air flow into and out of the work chamber, said upper housing having a front panel and said work chamber being enclosed on all sides except a front opening for work access into a work zone inside the work chamber for the performance of general microbiological work within the work zone, a slidable glass sash coupled to said frame, said sash movable to at least partially closing the front opening for work access and a microprocessor control and alarm system, characterized by the bio-safety cabinet having one or more of the following improvements:

### Microprocessor Improvements

### 1. Networking

The bio-safety cabinet is equipped with an RS 232 or RS 485 port so that the cabinet can be connected to a central computer that can control the cabinet's basic function, such as turning on/off the fan, lights, UV, and auxiliary electrical power socket. For the safety of the user working with the cabinet, this remote feature can be easily blocked and overridden by the manual control panel on the cabinet.

### 2. Multiple Downflow Sensors

The biosafety cabinet is equipped with multiple downflow sensors to detect and take the average of downflow velocity from multiple locations, to provide the user with a more accurate downflow velocity value, as displayed on the microprocessor panel.

### 3. Integrated Voltage and Filter Pressure Drop Compensation

The biosafety cabinet is equipped with an integrated blower voltage compensation system that would automatically increase the motor voltage due to building supply voltage variation and filter loading.

### 4. UV Intensity Meter

The biosafety cabinet has a built-in UV lamp intensity measurement meter, so the user knows whether the UV intensity is still sufficient or not.

### Airflow Improvements

### 1. Raised Arm Rest

The ergonomically-designed raised arm rest provides a comfortable place for the operator to put his/her arms during work, and prevents the inflow grille from being blocked by arms.

### 2. Convex-Shaped Inflow Grille

The convex-shaped inflow grille can prevent the user from placing objects on top of the inflow grille, and combined with the raised arm rest installed in front of the convex inflow grill, the arm rest will stop objects placed on the convex inflow grill from falling over to the front.

### 3. Angled Filter with Straight (Horizontal) Diffuser

The forward-angled downflow filter pushes air to the front part of the cabinet where it is needed most to preserve the front air barrier to protect the operator and product, and the straight diffuser evenly distributes airflow to create a uniform downflow throughout the cabinet work zone, including preventing the downflow on the back area from being too weak due to the forward-angled downflow filter.

### Decontamination Improvements

### 1. Anti-Microbial Coating

The anti-microbial coating in the form of silver ions embedded on the powder coating on the cabinet exterior and especially interior inhibits the growth of harmful microorganism, to help protect the safety of the service technician who performs filter of blower changing after the cabinet has undergo formalin decontamination.

### 2. UV Lamp Location

The UV lamp is positioned on the top upper edge of the work chamber which is shielded by a fluorescent light panel to prevent the user from directly staring onto the UV lamp.

### 3. Auto Decontamination

The biosafety cabinet has a wire connection port to the optional formalin and ammonia vaporizer module, so that the cabinet blower is automatically turned on according to a programmable time and duration, during the formalin and ammonia vaporization cycle to circulate the formalin and ammonia vapor.

### Glass Cleanability Improvement

The biosafety cabinet was designed in such a way that the front portion of the sash track can be easily removed so the sash glass can be lifted up to enable the user to clean the back (interior) side of the sash glass.

### BRIEF DESCRIPTION OF THE DRAWINGS

For a better understanding of the invention, its advantages, and the objects attained by its use, reference should now be made to the accompanying drawings. The accompanying drawings illustrate one or more embodiments of the invention and together with the description herein, serve to explain the workings and principles of the invention.

FIG. 1 is a 3-D view of the front and one side of the biosafety cabinet of the invention.

FIG. 2 is the top view of the biosafety cabinet of the invention.

FIG. 3 is the front view of the biosafety cabinet of the invention.

FIG. 4 shows the airflow pattern of the biosafety cabinet of the invention.

FIG. 5 shows the raised arm rest and the curved inflow grille, seen from inside of the cabinet.

FIG. 6 shows the front inflow grille.

FIG. 7 shows the single piece work tray with integrated front grille and recessed down work area with 45° angle at the front, left, right, and back side of the working area.

FIG. 8 shows the back air return grille as seen though the front opening.

FIG. 9 shows the inside part of the cabinet, when the side wall is removed.

FIG. 10 is a 2-D magnification of FIG. 9, showing the airflow effect of angled downflow filter and straight diffuser.

FIG. 11 shows the inside of the cabinet, with topic of discussion is the blower housing area, when the front cover is removed.

FIG. 12 shows the location of the connection port that enables the cabinet to “communicate” with the formalin & ammonia vaporizer.

FIG. 13 shows how to remove the sash track cover to enable the user to lift the sash window and clean the back surface of the window.

FIG. 14 shows the side-back view of the cabinet and the location of the RS232/RS 485 communication port to connect the cabinet to the network.

FIG. 15 shows the performance envelope of the cabinet; the blue area indicates the inflow and downflow combination on which the cabinet can provide operator and product protection as verified by microbiological testing.

FIG. 16 shows the multiple downflow sensors installed on the back interior wall of the cabinet, with the front panel removed.

FIG. 17 shows the interior side view of the cabinet.

FIG. 18 is a 2-D magnification of FIG. 17, showing the location of electrical inlet, pressure sensor, UV sensor, and microprocessor board.

### DETAILED DESCRIPTION OF THE INVENTION AND DRAWINGS

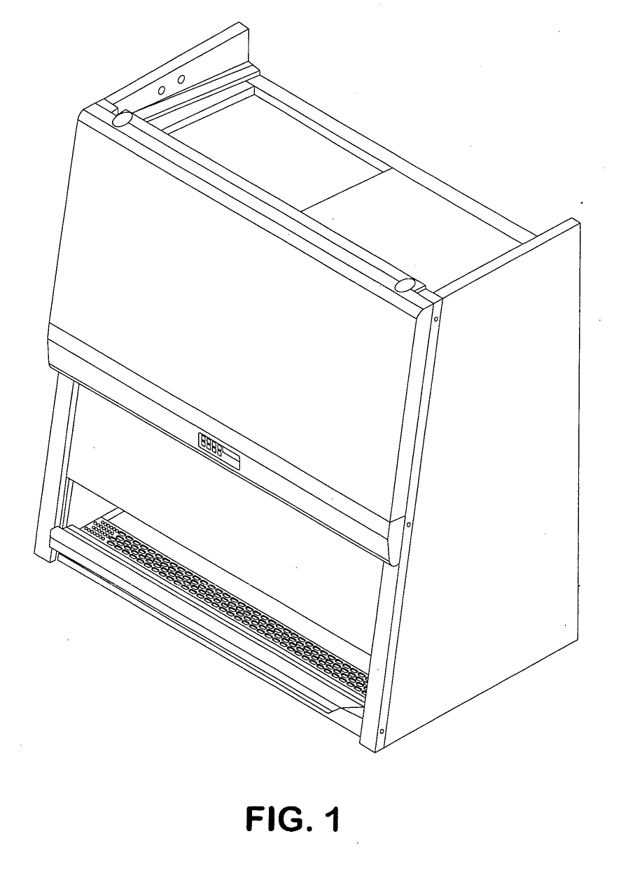

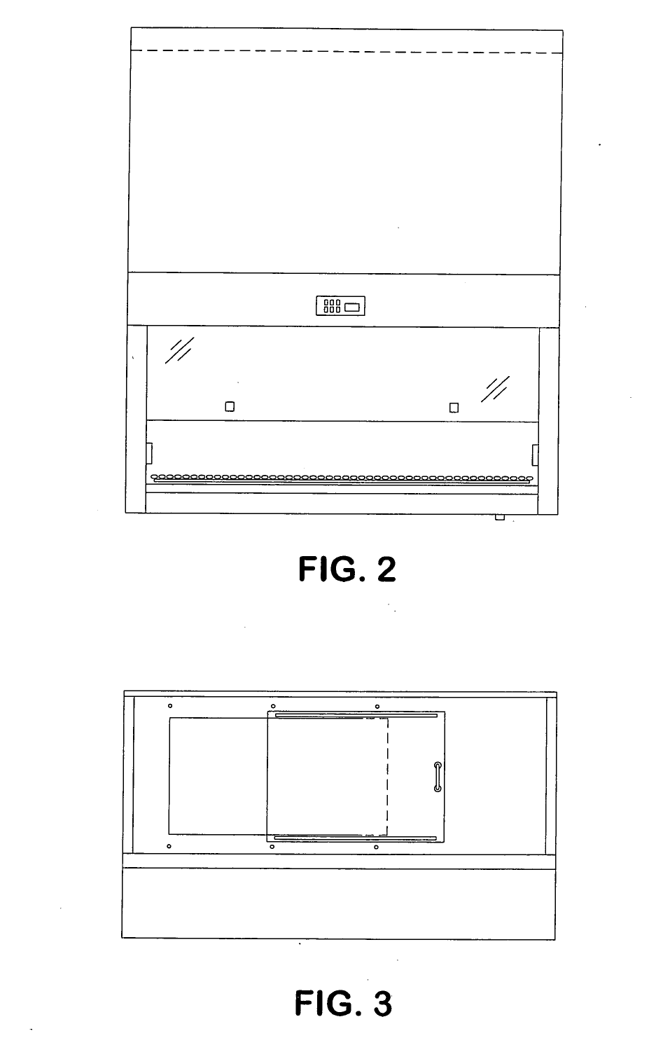

FIG. 1, FIG. 2, and FIG. 3 provide the exterior description of the biosafety cabinet of the invention.

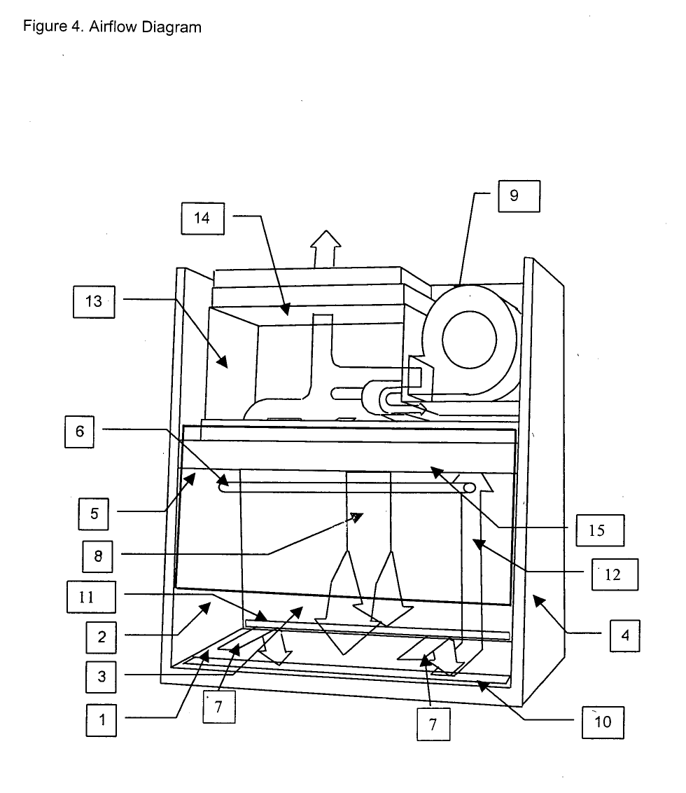

How the biosafety cabinet works is described on FIG. 4. The biosafety cabinet under discussion is an enclosure with a front opening, where the operator's hands can enter the work area to perform the microbiological work on the work surface area/work tray 1, which is surrounded by the inner left wall 2, inner back wall 3, and inner right wall 4. The front side has a partial/adjustable opening by sliding sash window 5. The front window opening should be set to a specified opening height when the microbiological work is performed. When the microbiological work is not performed, the window can be moved upward for easy cleaning of the cabinet work zone or for moving large equipment into or out from the biosafety cabinet. The front opening must be completely closed when the UV lamp 6 inside the biosafety cabinet is activated, to protect the operator from UV light exposure.

The operator is protected from microbiological agents inside the cabinet by inward-moving airflow through the front opening which is often referred to as inflow 7. The product/sample inside the cabinet is protected by a downward stream of clean and laminar air flow referred as downflow 8. The air inside the work zone is constantly purged and replenished to prevent microbiological contaminants from “jumping” from one area to another, which is referred to as cross contamination protection. The inflow, downflow, and work zone continuous air purging inside the cabinet are driven by electric blower(s)/fan(s) 9.

Below is a description of the air flows inside a biosafety cabinet:

Inflow: Room air flows through the front window opening into the front grille 10 on the work tray. Due to the cabinet design, inflow only travels as far inward as the front air grille, and does not enter the work zone to avoid product contamination.

Air return path: The inflow air stream travels through the air return path underneath the work tray and meets the downflow stream entering from the back grille 11. The combined stream, which is under negative pressure (lower pressure than ambient pressure), flows through the back air column 12, then flows around the fan housing before going into the fan inlet 9.

Fan/blower housing: The fan(s) inside the fan housing creates positive pressure (higher pressure relative to ambient pressure) inside the blower housing/plenum 13 to push the air through the HEPA/ULPA filters that would capture the microbiological contaminants. The fan housing is the most dangerous area inside the cabinet because the air inside the fan housing is contaminated and it's under positive pressure. However, the fan housing is surrounded by negative pressure created by the fan suction. Therefore, if there is some leakages through the fan housing, the contaminants will be aspirated by the negative pressure back into the fan housing and will not escape to the lab environment.

HEPA-filtered exhaust air: Approximately 35% of the air from the fan housing goes out to the room through the exhaust HEPA/ULPA filter 14 which captures the contaminant particles, thus preventing them from going out to the lab environment. Because of conservation of mass, the exhausted air is replenished by the inward moving air through the front opening (inflow) 7, which creates the operator protection.

HEPA-filtered downflow air: The remaining 65% air from the fan housing passes through the downflow HEPA/ULPA filter 15 that creates a unidirectional (laminar) air stream that continuously “bathe” the work zone with particle-free air to provide product protection. Near the work zone surface, the downflow will split and be drawn towards the front and back air grille by the negative pressure from the fan, thus continuously removing contaminants from the work zone. The downflow portion that flows towards the front air grille joins the inflow stream, creating an air barrier that prevents the contaminants inside the cabinet from escaping through the front opening and also preventing the outside contaminants from entering the cabinet work zone.

Proper inflow and downflow balancing is required to ensure the dual function of this air barrier. An imbalanced cabinet can lose it's operator protection and product protection.

The HEPA filters are at least 99.99% efficient at 0.3 micron particle size, so they are deemed suitable to capture viruses and bacteria that circulate inside the cabinet. A more advanced filter is called Ultra Low Penetration Air filter or commonly abbreviated as ULPA filter, which is at least 99.999% efficient at 0.12 micron particle size, thus offering a higher degree of protection than the HEPA filter.

### Airflow Improvements

### 1. Raised Arm Rest

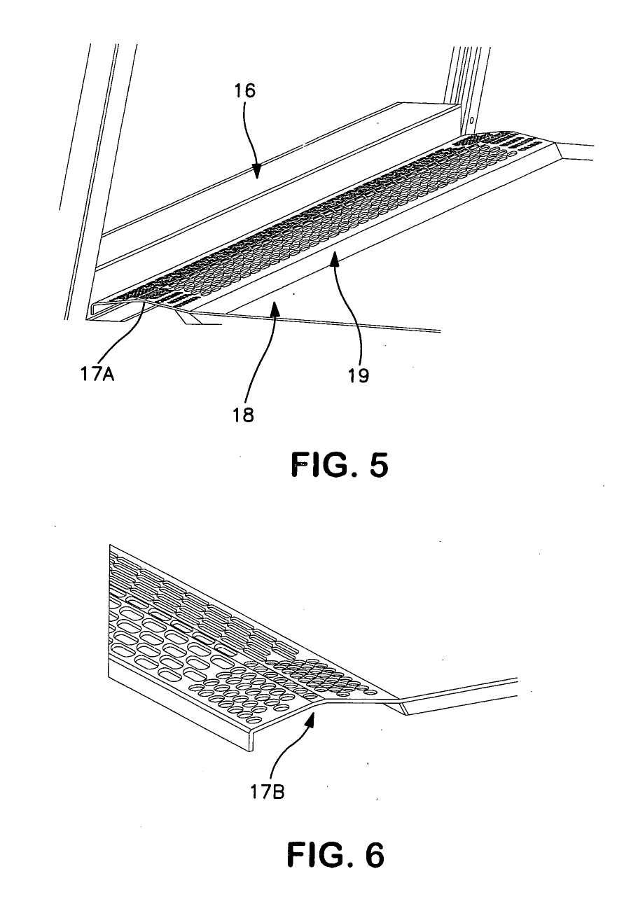

The object of this invention to provide an inflow air grille and armrest design at the frontal lower opening of the cabinet that ensures the air grille cannot be obstructed during normal use (thereby affecting the airflow at the front of the cabinet which may lead to a loss of operator protection) while maintaining maximum reach into the work zone while at the same time maximizing safety. Prior art designs have employed primarily a flat air grille at the front of the work zone which, during normal use, is easily obstructed by the operator's arms which are typically placed horizontally over the air grille. Please refer to FIG. 5 and FIG. 6. The present invention proposes an armrest 16 extending from the frontal lower face of the cabinet to support the operator's arms above the air grille 17A & 17B allowing for a reasonable clearance therefore ensuring the operator's arms will not obstruct the air grille potentially causing a loss of containment by the cabinet. Furthermore, the raised armrest design maximizes the reach of the operator into the work zone of the cabinet by creating the maximum vertical distance between the lower edge of the frontal sash to the work zone. However, as the armrest is raised, the reach distance defined by the vertical distance between the lower edge of the frontal sash to the work zone level is larger than the actual opening of the work zone front aperture (defined as the vertical distance between the armrest level—raised above the work surface—and the lower edge of the frontal sash). As the actual net work zone front aperture opening is minimized, the operator protection and safety of the cabinet will be improved as there is a small frontal surface from which contaminated materials can escape from the interior of the work zone to the exterior, while at the same time maximizing operator reach into the work zone and comfort.

### 2. Convex-Shaped Inflow Grille and Recessed Work Surface Area

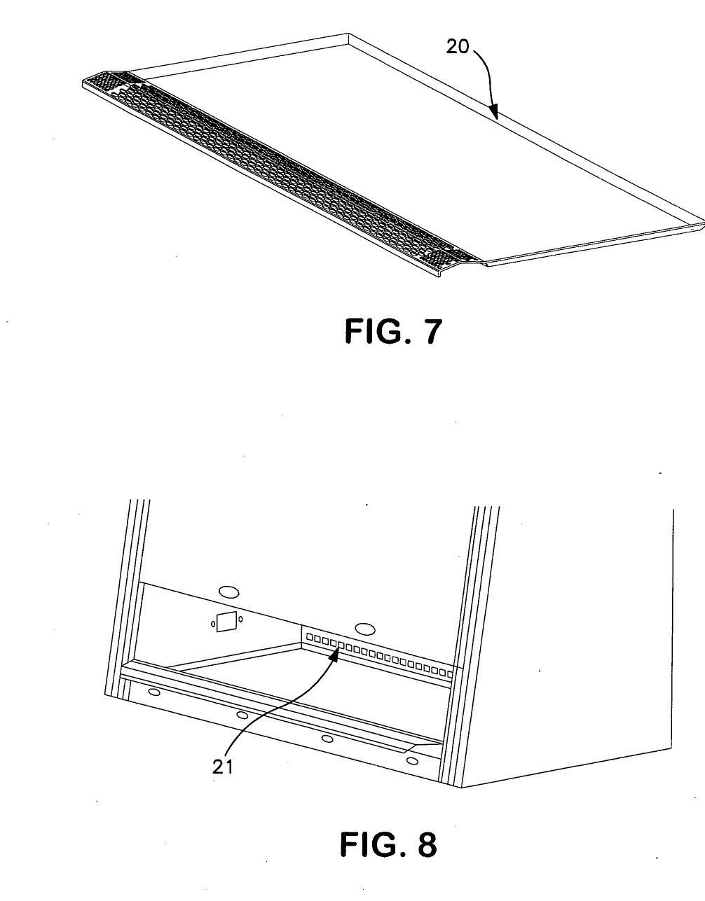

Please refer to FIG. 5, FIG. 6, FIG. 7, and FIG. 8. The convex-shaped inflow grille 17A & 17B can prevent the user from placing objects on top of the inflow grille, and combined with the raised arm rest installed in front of the convex inflow grill, the arm rest will stop objects placed on the convex inflow grill from falling over to the front. The chance of blocking the inflow grille is further minimized by having a recessed work surface area 18 that is sloping down 19 from the inflow grille 17A & 17B. Because the work surface area is recessed with respect to the back edge of the tray 20, the user also cannot put the object too close to the back air grille 21 that can block it.

### 3. Angled Filter with Straight (Horizontal) Diffuser

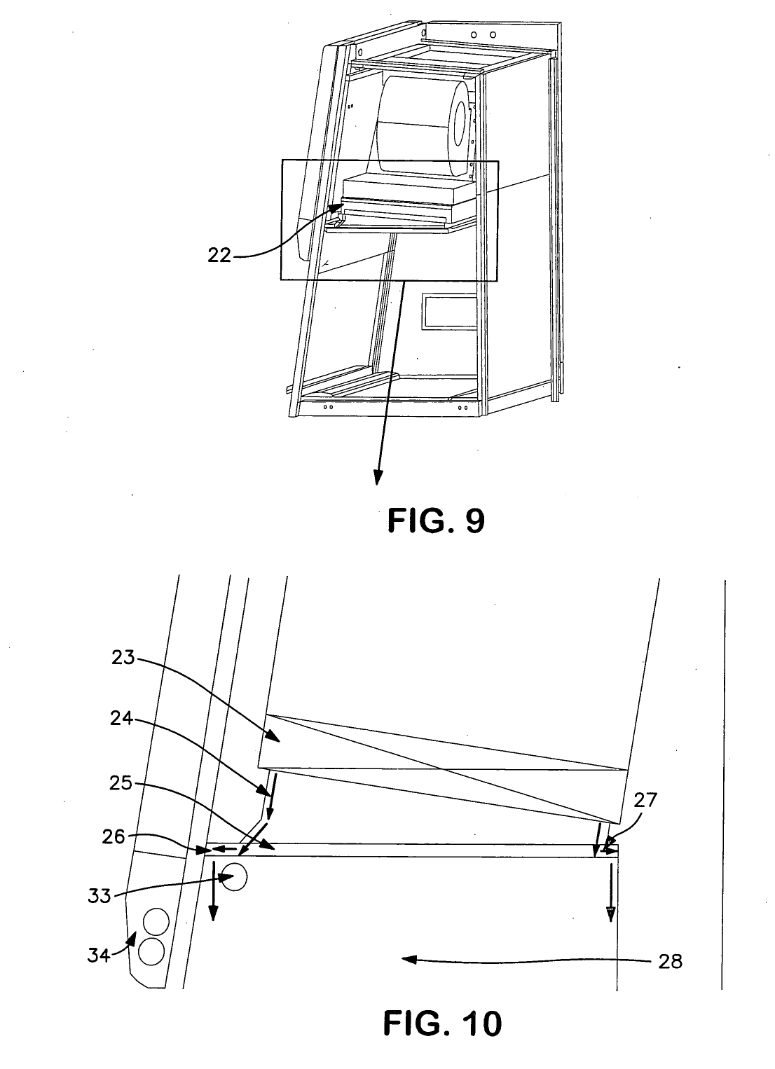

Referring to FIG. 9 and FIG. 10, increasing the down flow on the front area where it's needed most to create the front air curtain that prevents contaminants from inside to escape out or to prevent outside contaminants to creep inside is shown. The downflow filter 22, or in enlarged (FIG. 10) 2-D side view 23, is mounted at an angle, and directs the air to the front 24 to eliminate the dead air corner on the front side. The downflow diffuser 25, which is a perforated aluminium sheet with 3 mm hole diameter and 5 mm pitch that is installed underneath the filter spreads out the airflow throughout it's surface and then “bends” the airflow vertically downward so there is a laminar and uniform vertical air flow, thus preventing the dead air corner in the front 26 and on the back 27 of the work zone 28. The combination of an angled filter with straight diffuser eliminates dead air corner and ensures that the maximum downflow deviation is below 20%, as opposed to many prior art cabinets which declare the downflow uniformity as 20% or even worse, they have zoned downflow area in which typically the front, middle, and back sections of the work tray are sloped.

### Decontamination Improvements

### 1. Anti-Microbial Coating

The bio-safety cabinet of this invention has an anti-microbial powder-coating (commercially known as “Biocote”®) to minimize microbial contamination and inhibit microbial growth on the coated surface. The active ingredient in the anti-microbial powder-coating is the element silver in the form of silver ions, which is extremely effective against a wide range of micro-organisms and has a low toxicity against non-target organisms. Silver ions in the powder-coating bind to cells in micro-organisms and effectively interrupt their critical functioning, thus inhibiting growth of potentially hazardous bacteria, mould and fungi.

The biosafety cabinet of this invention is effective against the following examples of bacteria:
Staphylococcus Aureus (including MRSA)
Escherichia Coil (E-Coli)
Listeria Monocytogenes
Streptococcus faecalis
Salmonella enteritides
Aspergillus Niger (Black Mould)

The anti-microbial powder-coating is applied to the entire interior and exterior electro-galvanized steel and aluminium surface of the cabinet. The effectiveness lasts throughout the lifetime of the product, and does not wash out nor is it removed by cleaning. The anti microbial coating applied on the exterior of the cabinet helps to protect the user from exposure to microorganism that was released during their normal work or due to accidental release/spillage, that manages to land on the cabinet's exterior surface.

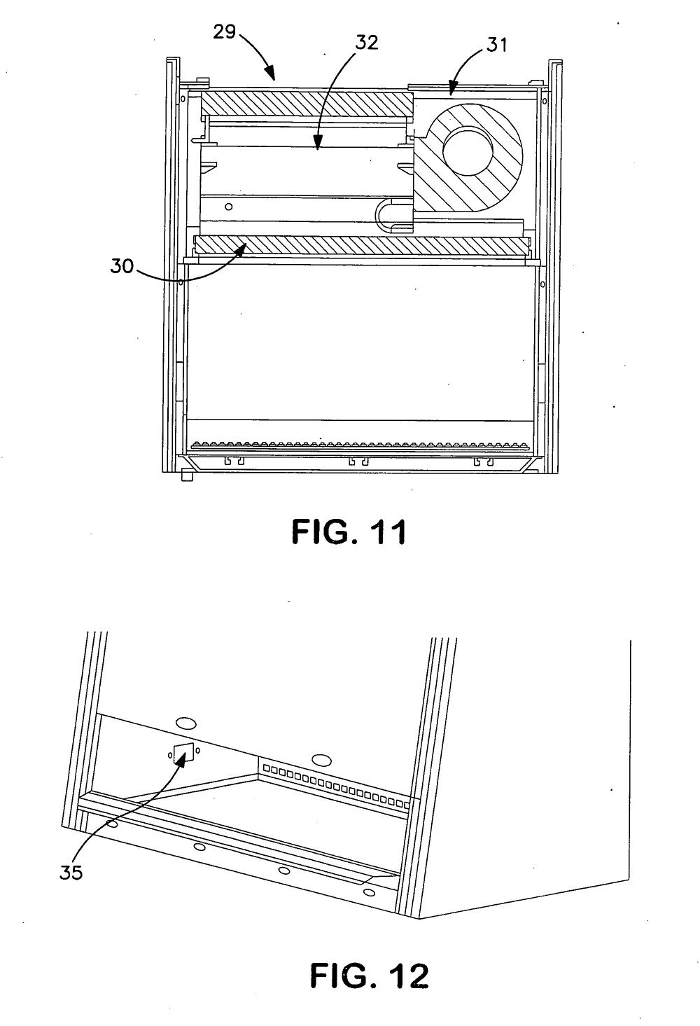

Please refer to FIG. 11. The microbial coating applied on the interior of the cabinet helps in protecting the safety of the technician who performs servicing of the cabinet, such as changing the exhaust filter 29, downflow filter 30, blower 31, or in accessing this contaminated plenum 32. Although the cabinet must undergo formalin decontamination prior to accessing all these contaminated interior parts, formalin decontamination can only reduce the number of hazardous microorganism inside the cabinet by a factor of 100,000 to 1,000,000, but will not achieve a complete kill of all microorganism. In practicality, quite often only a kill factor of between 10,000 to 100,000 is achieved. A small quantity of accidental spillage can release millions of microorganisms, and over a period of years, billions of microorganisms may accumulate inside the biosafety cabinet's contaminated area. Because of the limited effectiveness of formalin decontamination, there is still a risk for the service technician to get infected when accessing the contaminated area, therefore the anti-microbial coating offers a further degree of protection from the leftover microorganisms not killed by the formalin vapor.

To prevent rust and improve clean-ability on the work zone where contaminated spills normally occur, the drain pan, interior wall, and especially work surface of the cabinet are typically made of stainless steel material instead of electro galvanized steel. Stainless steel is not powder coated, because that would defeat the purpose of using stainless steel. The stainless steel smooth surface is easier to clean than a powder coated surface. To help in protecting the user from microbial infection from the work zone, where all the experiments are performed, the stainless steel material used on a biosafety cabinet of this invention is also anti-microbial stainless steel that also inhibits the growth of microorganism.

### 2. UV Lamp Location

FIG. 10 shows the position of the UV lamp 33 on the top upper edge of the work chamber which is shielded by fluorescent light panel 34. The UV lamp is placed away from the operator's line of sight, to prevent accidental staring towards the UV lamp. The UV lamp is positioned so that the light of the UV lamp will bath the entire work zone, completely covering the back wall, side walls, work tray, and the area behind the sash window. Some biosafety cabinets of the prior art have a modular UV lamp kit that is mounted on the stand on top of the work tray. While this brings the UV lamp closer to the work tray where all the experiments are performed, it cannot cover the middle and upper portion of the side walls, back wall, and the entire front window. Although the UV Lamp on the cabinet of the invention is located further up from the work tray, the UV light intensity on the work surface has been measured that the UV intensity is still three times the minimum required UV intensity exposure on the work tray on the work surface, thus ensuring the effectiveness of work tray decontamination.

For further user protection from the UV lamp, the biosafety cabinet of this invention uses sensors and switches on the sliding glass sash window, that are linked to the microprocessor control and alarm system that requires the sash window must be fully closed before the UV lamp can be activated. The UV lamp would be automatically cut-off even when the sash window is slightly raised. Furthermore, the switches used on this biosafety cabinet are magnetic switches, which have no moving parts and thus are not prone to wear and tear like mechanical switches used on several prior art biosafety cabinets.

### 3. Auto Decontamination

Decontamination by formalin vapor is required to be performed before the service technician can open up the contaminated parts of the cabinet, for example when changing the HEPA/ULPA filter or the changing the fan. During the formalin vaporization cycle, the biosafety cabinet blower needs to be turned on for a short time to circulate the formalin. If the formalin is not well distributed throughout the cabinet the decontamination will not be effective to achieve the necessary microbial kill ratio of 100,000 to 1,000,000 to help protect the service technician who will open up the contaminated area afterwards.

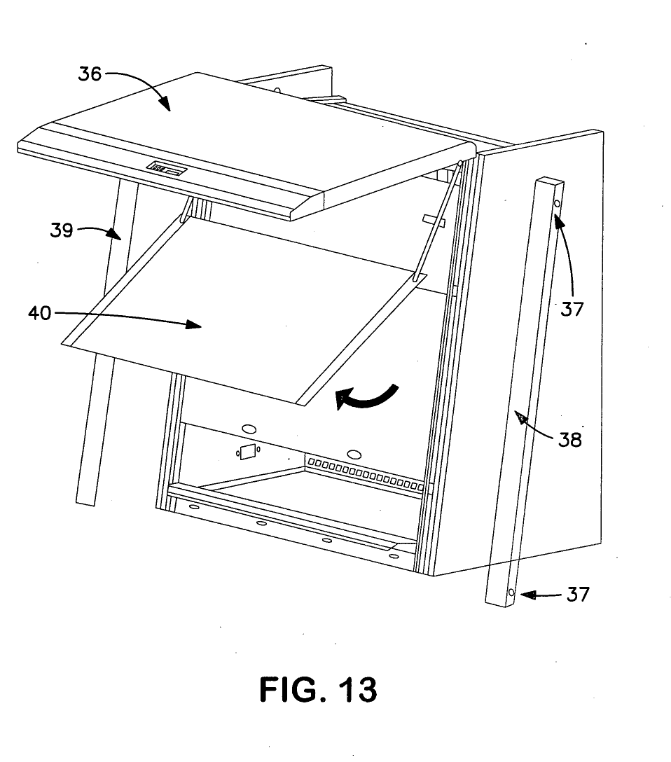

FIG. 12 shows the bio-safety cabinet with wire connection port 35 to the optional formalin and ammonia vaporizer module, so that during the formalin evaporation process, the vaporizer sends the signal to the biosafety cabinet's microprocessor to turn on the blower for a programmable time between ½ to 1 minute (depending on cabinet size) when the formalin is 25%, 50%, 75%, and 100% evaporated to circulate the formalin vapor throughout the cabinet. The blower run time depends on cabinet size, meaning that larger cabinets will require longer blower running time. If the running time is too short, there would not be complete formalin distribution. If the running time is too long, the formalin decontamination effectiveness may be reduced.

This automatic feature will save the service technician from the trouble of keeping track of the time to manually turn ON the cabinet's blower at the specific time, and also to ensure the technician's safety by ensuring proper formalin vapor distribution in case the technician forgets to turn on the blower, or turns it on at insufficient or excessive time.

Formalin vapor is carcinogenic and potentially lethal for humans, so after sufficient contact time of at least 6 hours (although 10 hours is better), the formalin needs to be removed. If the lab where the cabinet is located has no ducting system to extract the formalin vapor outside the cabinet and room, the formalin must be neutralized by ammonia.

The formalin-ammonia vaporizer for the biosafety cabinet of the invention can be programmed to start the ammonia vaporization process after sufficient formalin contact time of 6-12 hours. Like formalin, ammonia must also be thoroughly circulated inside the cabinet to neutralize the formalin. If the service technician starts the formalin vaporization at 5 pm, he/she does not need to come back in the middle of the night to turn on the blower. The vaporizer will automatically send a signal to the cabinet's microprocessor, to turn on the blower for ½ to 1 minute when the ammonia is 25%, 50%, 75%, and 100% evaporated. When the service technician comes back in the morning to start working on the cabinet's interior, the formalin decontamination and ammonia neutralization is already finished.

### Glass Cleanability Improvement

Referring to FIG. 13, the bio-safety cabinet is designed in such a way that the back side of the glass can be completely cleaned with relative ease. First, the front panel 36 is opened. Although the front panel is heavy, it is supported by 2 gas springs so the user requires relatively a small force to open the front panel. The gas spring also hold the front panel open. After that, the two screws 37 on the right 38 and left 39 sash track cover are removed, and then the sash glass can be lifted up so the user can clean the back (interior) side of the glass 40. Prior art bio-safety cabinets cannot have the area behind the glass sash cleaned easily or employ a complicated mechanism where the glass is mounted on a frame so that the entire glass and frame assembly must be lifted.

### Microprocessor Improvements

### 1. Networking

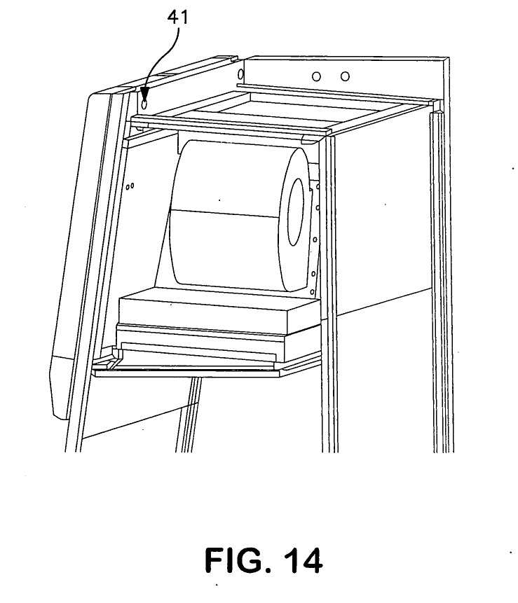

With reference to FIG. 14, the bio-safety cabinet is equipped with an RS 232 or RS 485 port 41 so that the cabinet can be connected to a central computer that can control the cabinet's basic function, such as turning on/off the fan, lights, UV, and auxiliary electrical power socket. For the safety of the user working with the cabinet, this remote feature can be easily blocked and overridden by the manual control panel on the cabinet. Moreover, this RS 232 or RS 485 interface is also used to connect the biosafety cabinet of the invention to a personal computer for diagnostics, software updates and parameter settings.

### 2. Multiple Downflow Sensors

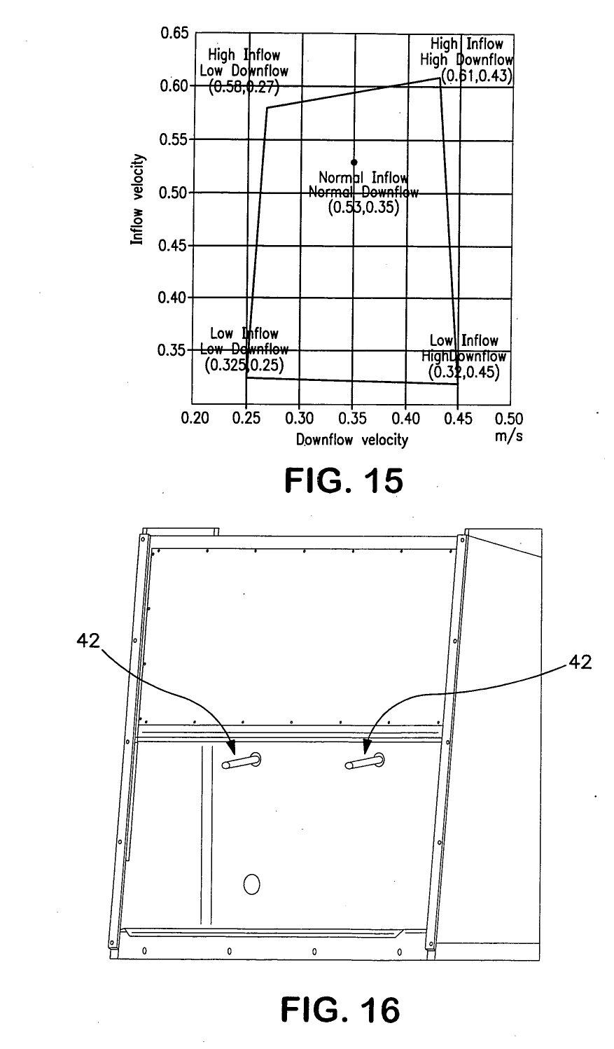

The cabinet can provide operator and product protection when the cabinet inflow and downflow is within a specific area called the cabinet performance envelope in FIG. 15. The boundary points of the cabinet performance envelope, in which the cabinet almost failed to give operator and or product protection is as follows:
High inflow, low downflow: operator protection is increased since microbial agents inside the cabinet must overcome stronger incoming air flow to escape from the work chamber. However, product protection can be compromised since particles from outside have a higher inward velocity thus higher chance of passing beyond the front air curtain and landing on the work tray.
Low inflow, high downflow: operator protection is decreased because the high downflow can induce contaminated air inside the work chamber to escape through the front opening. However product protection is increased because high downflow expels the incoming inflow from outside the cabinet. Additionally protection from cross contamination is increased because high downflow makes the purging of air inside the work chamber faster.
Low inflow, low downflow: both operator protection and product protection are decreased and in the lower airflow value, both protection cease to exist.
High inflow, high downflow: this is when the cabinet is operated at maximum voltage, and we want to know if there is bad combination of inflow and downflow velocity that can cause one of them to fail.

Therefore, the cabinet inflow and downflow must be accurately monitored to ensure that the cabinet is operated in this specific window, and when the cabinet is outside the operating window, the user is alerted by the biosafety cabinet of the invention, and the service technician can remedy the problem.

The cabinet of this invention is equipped with both inflow and downflow velocity sensors. The biosafety cabinets of the prior art have no sensor at all, only an exhaust sensor, or the best of them only has one exhaust sensor and one downflow sensor. If only one downflow sensor is used, the sensor only measures the air velocity at one point below the downflow HEPA/ULPA filter. Considering the downflow filter typically has twice the surface area of the exhaust filter, it is also twice as likely to have non-uniform filter loading.

FIG. 16 shows the bio-safety cabinet of this invention equipped with multiple downflow sensors 42 to detect and take average of downflow velocity from multiple locations. Therefore, the user of this cabinet does not have to solely rely on one point reading from one downflow sensor used in prior art biosafety cabinets.

The downflow reading from multiple sensors on this biosafety cabinet of the invention is then correlated to the average downflow reading, measured per NSF49:2002 standard, which states that the downflow velocity measurement must be taken on a grid point system that is 6 inches (15 cm) from the front window, side walls and back wall, and the distance between one reading point to another shall not exceed 6 inches (15 cm). This NSF grid system requires 24 point reading for typical 4 ft wide cabinets that is commonly sold in the market, or more points for larger cabinets, for example on 6 ft wide cabinets.

The multiple downflow sensor reading on the biosafety cabinet of the invention can give a more accurate representation of the average downflow reading taken on 24 points compared to single point downflow reading on prior art biosafety cabinet, especially when the cabinet has been used for several years and there is an uneven particle loading on the downflow filter, where the filter area near the sensor is not severely blocked by the dust compared to the rest of the filter area, so the downflow velocity where the one sensor is installed is still high, whereas the average downflow velocity of the entire filter area is low.

The use of multiple downflow sensors can prevent a false sense of security of having sufficient downflow, although the downflow is not strong enough to provide product protection from contamination. By having a more accurate downflow reading, the user can receive a warning by the microprocessor in a more accurate timing when the downflow is not enough, so the user can contact the service technician earlier to either change the blower setting or change the downflow filter.

### 3. Integrated Voltage and Filter Pressure Drop Compensation

The operator protection of the cabinet is provided by inflow and product protection is provided by downflow. Inflow and downflow velocity of the cabinet can change in the short or long term, affecting the protection provided by the cabinet. The cabinet of the invention incorporates an integrated voltage compensation speed control to prevent short term airflow change, and filter pressure compensation to prevent long term airflow change.

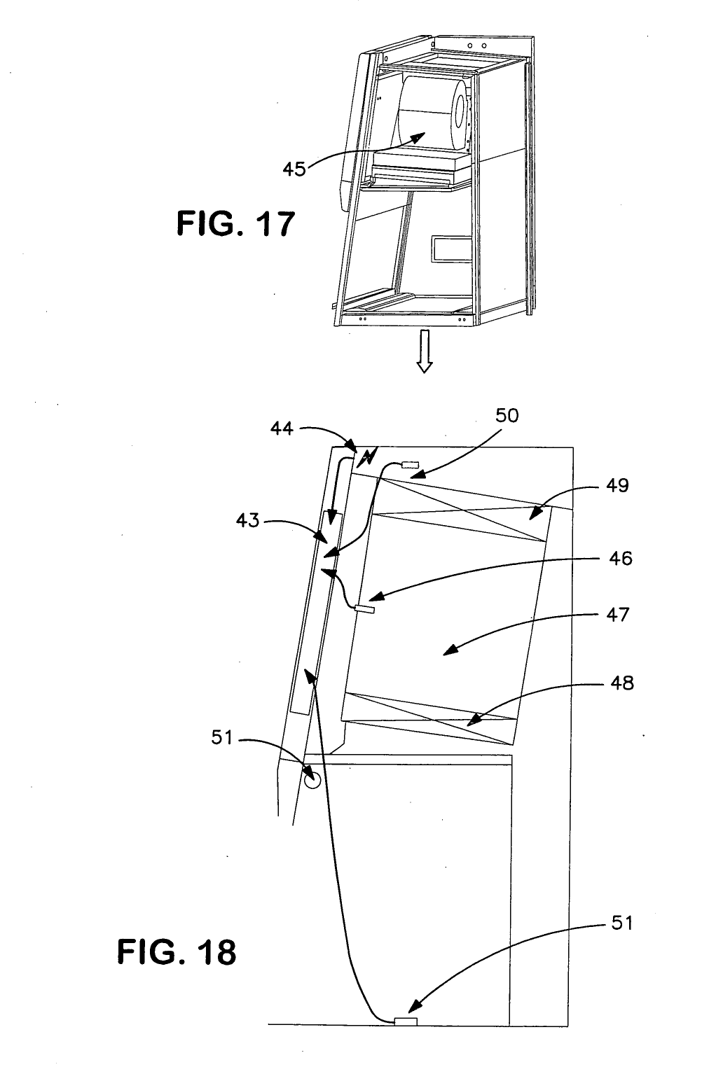

Short-term airflow change is caused by building supply voltage fluctuation. The supply voltage can be low during the day where all the machineries are operated, and high during the night. If a conventional (non-compensation) speed control is used, it will cause the blower speed to fluctuate according to the building supply voltage. Please refer to FIG. 17 and FIG. 18 to see how this problem is solved on the cabinet of the invention. The microprocessor 43 of this biosafety cabinet is equipped with an integrated blower voltage compensation system 44 that automatically keeps the blower 45 voltage constant, despite building supply voltage fluctuations. This eliminates the danger of having the inflow and downflow too low to provide protection when the building supply voltage goes down.

The voltage compensation system also eliminates the frustration of the field certifier who does not have to set the cabinet normal operating voltage to an optimum point between the lowest or average building power supply. For cabinets that are not equipped with the voltage compensation speed controller, if the certifier sets the speed control at the average building power supply, then when the HEPA/ULPA filter get slightly loaded and the building power supply is getting low, the airflow potentially becomes too weak and the alarm will be activated, prompting the user to stop work and call the certifier. If the certifier adjusts the speed control according to the lowest building supply, then when the building supply is high, the blower is running at high speed which creates a high noise that can annoy the user, and also shorten the HEPA/ULPA filter life. However, with the voltage compensation speed control installed on the cabinet of the invention, the voltage supplied to the blower is kept constant, although the building power supply fluctuates. Therefore, the user will not be troubled by a frequent airflow alarm at low voltage or high blower noise at high voltage.

Long-term (gradual) airflow change is caused by filter loading. Over a period of time, the HEPA/ULPA filter of the biosafety cabinet will gradually yield higher pressure drop due to increased filter loading by dust/particles that are captured by the filter. Because of this, the certifier typically need to check the cabinet once a year, measure the inflow and downflow, and adjust the speed control accordingly. Sometimes the filter loading is so severe that the airflow is insufficient before the certifier's annual check-up.

Referring to FIG. 17 and FIG. 18, to solve the long term airflow change problem, the cabinet of the invention is equipped with a pressure sensor that detects the pressure upstream of the filters 46, inside the blower housing 47. This is the pressure created by the blower 45 that is required to push the air across the downflow 48 and exhaust 49 HEPA/ULPA filters. The filters tend to resist the air movement and create a pressure drop. A pressure sensor is also used to measure the pressure downstream of the filter 50, which is the same as the ambient pressure.

By comparing the pressure upstream and downstream of the filters, the system can measure the pressure drop across the filters, and also compensating for different ambient pressure when the cabinet is installed at high altitude that has low ambient pressure. When the filters get increasingly loaded by particles, the filters yields higher pressure drop. This causes higher pressure differential between the pressure inside the blower housing and ambient pressure.

A voltage-compensation speed control alone will not compensate for filter loading, and a pressure-compensation system will not work well for building voltage fluctuation. Therefore, both systems are integrated to work with the microprocessor of the bio-safety cabinet of the invention.

Some cabinets of the prior art incorporate airflow sensor-based compensation, in which the speed control is automatically adjusted based on the airflow velocity detected by the airflow sensor. This initially seems like an efficient system, because as the airflow detected by the sensor is insufficient, due to either low building supply voltage or filter loading, no matter what is the reason, the blower speed is automatically increased. However, as mentioned earlier, the airflow velocity sensor can only measure a single point reading. If the filter is non-uniformly loaded by particles, the single point reading will not be an accurate representative of the overall airflow velocity throughout the entire filter area. Therefore, if this airflow sensor-based compensation system is used, it will not be accurate.

Another problem with the airflow sensor-based compensation is that the airflow sensor is susceptible to external airflow disturbance, from room air conditioner, door opening, people walking, etc. Most of the airflow sensors used on biosafety cabinets are thermo-anemometer sensors, which detect the airflow velocity based on the “cooling effect” of the heated wire. If more air (higher air velocity) passes though this heated wire, it will cool down faster and yield a higher DC voltage that is interpreted by the microprocessor as higher airflow velocity. However, if the air passing through this “sensor window” is already cold (like in the winter), the “cooling effect” is higher, and the microprocessor will register higher velocity than the actual velocity, creating a false sense of security. If such compensation system is used, then the extra voltage supplied to the blower will not be enough. Otherwise, if the room is hot, the system will over-compensate, making the blower run faster that it should be.

Because the voltage compensation and pressure compensation in the cabinet of the invention is not affected by non-uniform filter loading, external airflow disturbance, or room temperature fluctuation, it is a more reliable compensation system than the airflow sensor-based compensation.

### 4. UV Intensity Meter

The UV lamp must be able to yield UV intensity of 40 micro Watt/cm² on the work tray to sufficiently disinfect the work area. Over a period of time, the UV lamp will wear out and its' intensity decreases. UV intensity measurement is not mandatory for annual certification of the biosafety cabinet. Because of the extra cost of purchasing the UV meter, most field certifiers do not buy a UV meter to verify the UV intensity, so typically the UV intensity ended up not being verified by anyone.

Referring to FIG. 18, the microprocessor 43 of this biosafety cabinet of this invention is connected to a built-in UV lamp intensity measurement meter 50, so the user knows whether the intensity of the UV lamp 51 is still enough or not, and he/she can order the replacement UV lamp when the intensity is not enough.

While an embodiment of the invention have been described in detail, it should be apparent, however, that other modifications, rearrangements, substitutions, alterations and adaptations in addition to these embodiments may occur to persons skilled in the art with the attainment of some or all of the advantages of the present invention. Accordingly, it should be clearly understood that the present invention is not intended to be limited by the particular features and structures hereinbefore described and depicted in the accompanying drawings. It is therefore intended to cover all such modifications, alterations and adaptations without departing from the scope and spirit of the present invention as defined by the appended claims.

1. A bio-safety cabinet comprising: an all metal frame defining an upper housing on top of a lower protected work chamber, said upper housing fitted with a combination of exhaust and downflow ULPA filters and a blower sealed within said upper housing to provide air inflow and air downflow into said work chamber, air outflow out of said work chamber, said upper housing having a front panel and said work chamber being enclosed on all sides and a back and having a front opening for work access into a work zone inside said work chamber for the performance of general microbiological work within said work zone, a slidable glass sash coupled to said frame, said sash movable to at least partially close said front opening for work access, and a microprocessor control and alarm system, and a plurality of downflow sensors positioned at multiple locations within said cabinet for detecting the downflow velocity of said air downflow and providing the results of said detection to said microprocesser, wherein said microprocessor determines the average of said detection results.

2. The bio-safety cabinet as claimed in claim 1, further comprising:
an RS 232 or RS 485 port for connection of said cabinet to a central computer to remotely control functions of said cabinet selected from the group consisting of turning on/off said blower, lights in said cabinet, a UV lamp in said cabinet, an auxiliary electrical power socket in said cabinet, and combinations thereof, and wherein said cabinet's remote feature can be blocked and overridden by a manual control panel on said cabinet.

3. The bio-safety cabinet as claimed in claim 1, further comprising:
a plurality of pressure sensors to monitor upstream and downstream filter pressure to measure and adjust pressure drops across said filters.

4. The bio-safety cabinet as claimed in claim 3, further comprising:
an integrated blower voltage compensation system connected to the plurality of downflow sensors and plurality of pressure sensors to automatically maintain a constant supply of voltage to said blower and maintain constant velocity of the air inflow and downflow.

5. The bio-safety cabinet as claimed in claim 1, further comprising:
a UV lamp intensity measurement meter.

6. The bio-safety cabinet as claimed in claim 1, further comprising:
a convex-shaped inflow grille; and an ergonomically-designed raised arm rest adapted to receive the arms of the operator and which prevents said inflow grille from being blocked by said arms.

7. The bio-safety cabinet as claimed in claim 6, further comprising:
a forward-angled downflow filter which directs said downflow air to the front of the cabinet where it meets with said air inflow to form a front air barrier to protect the operator and product.

8. The bio-safety cabinet as claimed in claim 7, further comprising:
a straight diffuser which evenly distributes airflow to create a uniform downflow throughout the cabinet work zone, including preventing the downflow on the back area from being too weak due to the forward-angled downflow filter.

9. The bio-safety cabinet as claimed in claim 1, wherein said cabinet has an anti-microbial coating in the form of silver ions embedded on a powder coating on the cabinet exterior and the interior to inhibit growth of harmful microorganism, said anti-microbial coating being applied onto the stainless steel material, wherein the stainless steel used is also anti-microbial stainless steel which also inhibits the growth of microorganism.

10. The bio-safety cabinet of claim 1, further comprising
a UV lamp positioned on the top upper edge of the work chamber where it is shielded by a fluorescent light panel to prevent the user from directly staring onto the UV lamp.

11. The bio-safety cabinet of claim 1, further comprising a formalin and ammonia vaporizer module and a wire connection port to said formalin and ammonia vaporizer module, wherein said blower is automatically turned on by said microprocessor according to a programmable time and duration, to circulate the formalin and ammonia vapor.

12. The bio-safety cabinet as claimed in claim 1, further comprising a removable front portion of a glass sash track, the removability of which provides allows for said glass sash to be lifted up for cleaning of the back (interior) side of said glass sash.
